(19) United States
(12) Patent Application Publication
(10) Pub. No.: US 2026/0204110 A1
(43) Pub. Date: Jul. 16, 2026

(54) INFORMATION TRANSMISSION APPARATUS

(71) Applicant: SUBARU CORPORATION, Tokyo (JP)

(72) Inventors: Takanori TATEBE, Tokyo (JP); Tomohiro OKA, Tokyo (JP)

(21) Appl. No.: 19/563,122

(22) Filed: Mar. 11, 2026

Related U.S. Application Data
(63) Continuation of application No. PCT/JP2023/036713, filed on Oct. 10, 2023.

(51) Int. Cl. G07C 5/08

(52) U.S. Cl. CPC G07C 5/0816; G07C 5/0808

(57) ABSTRACT

An information transmission apparatus provided in a vehicle includes a parameter detector, a main information transmission device, a vibration generator, a vibration adjuster, and a malfunction detector. The parameter detector detects a parameter correlated to an amount of operation of a driving operation device of the vehicle. The main information transmission device generates a predetermined vibration waveform in accordance with an amount of change of the parameter per unit time. The vibration generator generates vibration to be applied to air around an occupant of the vehicle. The vibration generator has a function other than a vibration generating function. The vibration adjuster adjusts magnitude of the vibration in accordance with the amount of change of the parameter per unit time. The malfunction detector detects a malfunction of the main information transmission device. The vibration adjuster drives the vibration generator when a malfunction of the main information transmission device is detected.

### CROSS-REFERENCE TO RELATED APPLICATIONS

This application is continuation of International Application No. PCT/JP2023/036713 filed on Oct. 10, 2023, the entire contents of which are hereby incorporated by reference.

### BACKGROUND

The disclosure relates to an information transmission apparatus that transmits information on the behavior of a vehicle to an occupant of the vehicle.

As a technology of outputting sound to an occupant of a vehicle, such as an automobile, in accordance with the state of the vehicle, Japanese Unexamined Patent Application Publication (JP-A) No. 2007-62706 discloses the following driving assistance system. In this driving assistance system, the steering amount of the steering wheel of a vehicle is represented by sound that is variable in accordance with the steering amount. This allows an occupant of the vehicle to recognize the steering angle and the steering direction. For example, as the steering amount of the steering wheel is greater, the sound scale becomes higher. The steering amount of the steering wheel is also represented by other features of the sound, such as the intensity, pitch, tone, pressure, frequency, and the position of a sound image, which are also variable in accordance with the steering amount.

JP-A No. 2016-66912 discloses a music generating device for a vehicle, which can easily generate music that reflects the behavior of the vehicle or the operation of a human driver. The music generating device includes a storage unit and a control unit. The storage unit stores multiple sound source loop patterns associated with various items of information based on the operation of a human driver or the behavior of the vehicle. The control unit performs control to select a specific sound source loop pattern from the sound source loop patterns in accordance with the associated item of information and to output or stop outputting the selected sound source loop pattern.

### SUMMARY

An aspect of the disclosure provides an information transmission apparatus configured to be provided in a vehicle. The information transmission apparatus includes a parameter detector, a main information transmission device, a vibration generator, a vibration adjuster, and a malfunction detector. The parameter detector is configured to detect a parameter correlated to an amount of operation of a driving operation device of the vehicle. The main information transmission device is configured to generate a predetermined vibration waveform in accordance with an amount of change of the parameter per unit time. The vibration generator is configured to generate vibration to be applied to air around an occupant of the vehicle. The vibration generator has a function other than a function of generating vibration. The vibration adjuster is configured to adjust magnitude of the vibration to be generated by the vibration generator in accordance with the amount of change of the parameter per unit time. The malfunction detector is configured to detect a malfunction of the main information transmission device. The vibration adjuster is configured to drive the vibration generator when a malfunction of the main information transmission device is detected.

An aspect of the disclosure provides an information transmission apparatus configured to be provided in a vehicle. The information transmission apparatus includes circuitry. The circuitry is configured to detect a parameter correlated to an amount of operation of a driving operation device of the vehicle. The circuitry is configured to generate a predetermined vibration waveform in accordance with an amount of change of the parameter per unit time. The circuitry is configured to cause a vibration generator to generate vibration to be applied to air around an occupant of the vehicle. The vibration generator has a function other than a function of generating vibration. The circuitry is configured to adjust magnitude of the vibration to be generated by the vibration generator, in accordance with the amount of change of the parameter per unit time. The circuitry is configured to detect a malfunction of the information transmission apparatus. The circuitry is configured to drive the vibration generator when a malfunction of the information transmission apparatus is detected.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic view illustrating the configuration of an electric power steering system of a vehicle including an information transmission apparatus of an embodiment of the disclosure;

FIG. 2 is a block diagram schematically illustrating the system configuration of a main information transmission device of the embodiment;

FIGS. 3A and 3B are graphs schematically illustrating examples of a vibration waveform generated in the main information transmission device of the embodiment;

FIG. 4 is a graph schematically illustrating the timings of electric pulses generated by sensory receptors when they are stimulated;

FIG. 5 is a graph illustrating the sensitivity distribution of the Pacinian corpuscles and that of the Meissner corpuscles with respect to the frequency;

FIG. 6 is a graph schematically illustrating an example of gain adjustment performed by a first gain adjuster;

FIG. 7 is a graph schematically illustrating an example of the output history of a microphone;

FIG. 8 is a graph illustrating an example of the correlation between the frequency and the sound pressure of background noise;

FIG. 9 is a graph schematically illustrating an example of gain adjustment performed by a second gain adjuster;

FIG. 10 is a schematic view illustrating the arrangement in a compartment of a vehicle equipped with the information transmission apparatus of the embodiment;

FIG. 11 is a block diagram schematically illustrating the system configuration of a backup information transmission device of the information transmission apparatus of the embodiment;

FIG. 12 is a graph illustrating the setting of the drive voltage by a control voltage setter;

FIG. 13 is a graph illustrating the difference in the sound level in the compartment of the vehicle in accordance with whether a compressor is ON or OFF;

FIG. 14 is a graph schematically illustrating an example of the vibration generation characteristics of a motor or a compressor; and

FIG. 15 is a block diagram schematically illustrating the configuration of an autonomous driving system of a vehicle equipped with an information transmission apparatus of an embodiment.

### DETAILED DESCRIPTION

There is a time response delay from when a vehicle starts steering until when the corresponding behavior of the vehicle, such as the lateral acceleration, yaw rate, or roll angle, is exhibited. Depending on the situation of the steering operation, an occupant of the vehicle may feel that the behavior of the vehicle, such as the lateral acceleration, is abruptly exhibited and be unable to hold the body and may feel uncomfortable or uneasy.

As the countermeasures against such a situation, the yaw rate gain with respect to the steering angle of the vehicle may be lowered, or the designing feature of seats to securely hold occupants may be improved.

Lowering the yaw rate gain, however, slows down the responsiveness of the vehicle, which impairs the performance and the merchantability of the vehicle. Regarding the improving of the designing feature of seats, it may be difficult to suitably design seats to be adaptable to all occupants having different figures.

If an information presentation device is provided to output a sound signal in accordance with the amount of operation performed by a human driver on a driving operation device, the predictability of an occupant regarding how the vehicle will behave in response to a driving operation of the vehicle can be improved.

Such an information presentation device presents information by using a sound generating device, such as a speaker or a vibrator. If the sound generating device, such as a speaker, malfunctions, the effect of presenting information is impaired. It is thus desired that a tactile-vibration information presentation function is made up for by existing hardware loaded in a vehicle (an automobile, for example) so as to avoid the loss of the function of the information presentation device even in case of the occurrence of a malfunction.

In terms of the above-described issue, it is desirable to provide an information transmission apparatus that can improve the predictability of an occupant of a vehicle regarding how the vehicle will behave in response to a driving operation of the vehicle even when a malfunction occurs in an element of the information transmission apparatus, such as a speaker.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### First Embodiment

An information transmission apparatus according to a first embodiment of the disclosure will be described below.

The information transmission apparatus according to the first embodiment is provided in a four-wheeled vehicle (an automobile such as a passenger car, for example) that steers two front wheels, for example.

The information transmission apparatus includes a main information transmission device 100 for a regular use and a backup information transmission device 300 for a backup use, such as for when the main information transmission device 100 malfunctions.

The vehicle includes an electric power steering (EPS) system that applies steering assist force by using an electric motor to a steering device which steers the front wheels.

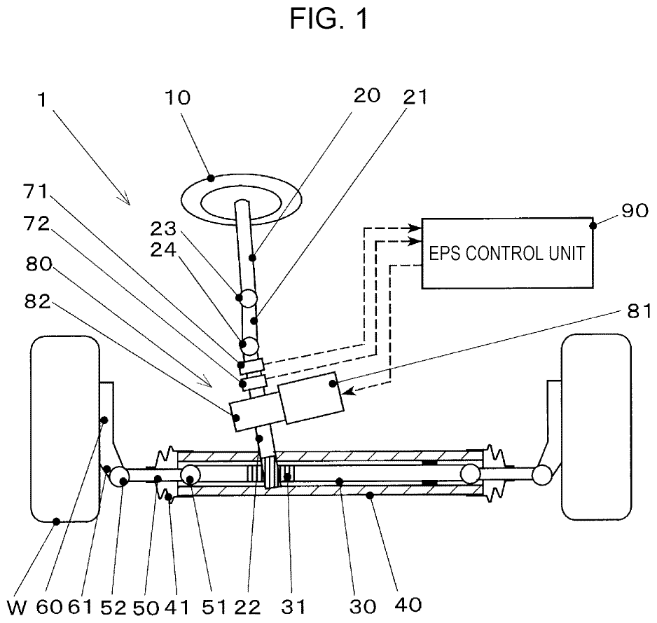

FIG. 1 is a schematic view illustrating the configuration of an EPS system 1 of the vehicle in the first embodiment.

The electronic power steering (EPS) system 1 includes a steering wheel 10, a steering shaft 20, an intermediate shaft 21, a pinion shaft 22, a rack shaft 30, a rack housing 40, a tie rod 50, a housing 60, a steering angle sensor 71, a torque sensor 72, an actuator unit 80, and an EPS control unit 90, for example.

The steering wheel 10 is, for example, a ring-shaped operation member rotated by a human driver to input a steering operation.

The steering wheel 10 is located to face the driver's seat in the compartment of the vehicle.

An occupant (driver) senses steering feel of the vehicle based on the sense of touch (tactile sense) transmitted from the steering wheel 10 to the fingers.

The steering shaft 20 is a rotating shaft fixed at one end to the steering wheel 10 to transmit a rotating operation of the steering wheel 10 to a rack and pinion mechanism. The rack and pinion mechanism converts the rotating operation of the steering wheel 10 to a translational motion in the widthwise direction of the vehicle.

The intermediate shaft 21 and the pinion shaft 22 are coupled to the other end of the steering shaft 20 in this order, that is, at the side opposite the side at which the steering shaft 20 is coupled to the steering wheel 10.

A universal joint (Cardan joint) 23 is disposed between the steering shaft 20 and the intermediate shaft 21, while a universal joint 24 is disposed between the intermediate shaft 21 and the pinion shaft 22. The universal joint has two shafts inclined to each other and can transmit a rotating motion.

A pinion gear, which is formed at the forward end of the pinion shaft 22, engages with a rack gear 31 of the rack shaft 30 to drive the rack shaft 30.

The rack shaft 30 is a columnar shaft whose longitudinal direction (axial direction) matches the widthwise direction of the vehicle. The rack shaft 30 is supported by the vehicle body so as to linearly move along the widthwise direction of the vehicle.

The rack gear 31 is formed on part of the rack shaft 30 to engage with the pinion gear of the pinion shaft 22. The rack gear 31 is driven by the pinion gear in accordance with the rotation of the steering shaft 20 so that the rack shaft 30 moves linearly (straight) along the widthwise direction of the vehicle.

The rack gear 31 is located to shift toward the left side or the right side (normally on the side of the driver's seat) in the widthwise direction of the vehicle. For example, if the vehicle is a right-hand drive vehicle having the driver's seat on the right front side, the rack gear 31 is disposed toward the right side with respect to the center of the vehicle that is in the neutral state.

The rack housing 40 is a substantially cylindrical member that houses the rack shaft 30 therein while supporting the rack shaft 30 to allow it to be displaceable in the widthwise direction of the vehicle.

A rack boot 41 is provided at each side of the rack housing 40. The rack boot 41 is a member that protects the rack housing 40 from the invasion of foreign matter, such as dirt, while allowing the tie rod 50 to be displaceable with respect to the rack housing 40. The rack boot 41 is made of a resin material, such as elastomer, and is formed in a tubular bellows shape having flexibility.

The tie rod 50 is a shaft-like interlocking member that links the end of the rack shaft 30 to a knuckle arm 61 of a housing 60 and causes the housing 60 to rotate on a kingpin axis together with the translational motion of the rack shaft 30.

The inner side end of the tie rod 50 in the widthwise direction of the vehicle is pivotably coupled to the end of the rack shaft 30 via a ball joint 51. The outer side end of the tie rod 50 in the widthwise direction of the vehicle is coupled to the knuckle arm 61 of the housing 60 via a ball joint 52.

The housing (knuckle) 60 is a member that houses a hub bearing therein. The hub bearing supports a wheel W so that the wheel W is rotatable on the axle. The housing 60 includes the knuckle arm 61 that is formed to project toward the front side or the rear side with respect to the axle.

The housing 60 is supported to be rotatable on the kingpin axis, which is a predetermined rotation center axis. The kingpin axis is, if the front suspension of the vehicle is the MacPherson strut, for example, an imaginary axis that links the center of a bearing of a strut top mount and the center of a ball joint, which couples the lower part of the housing 60 and a transverse link (lower arm).

The housing 60 is pushed and pulled along the widthwise direction of the vehicle by the rack shaft 30 via the tie rod 50 so as to rotate on the kingpin axis and steer the wheel W.

The steering angle sensor 71 is an angle encoder that detects the rotation angle/position of the pinion shaft 22.

Output from the steering angle sensor 71 is transmitted to the EPS control unit 90. The EPS control unit 90 is able to calculate the steering angle (change in the toe angle resulting from steering) θ of the wheel W, based on the output from the steering angle sensor 71.

The torque sensor 72 is a sensor that detects torque (mainly steering force generated by a human driver) acting on the pinion shaft 22.

On the pinion shaft 22, the torque sensor 72 is disposed at a position closer to the intermediate shaft 21 than the actuator unit 80 is. Output from the torque sensor 72 is transmitted to the EPS control unit 90.

The actuator unit 80 is a drive device that drives the pinion shaft 22 to rotate so as to assist a human driver with steering in manual driving and to steer in autonomous driving.

The actuator unit 80 includes a motor 81 and a gearbox 82, for example. The motor 81 is an electric actuator that generates driving force to be applied to the steering shaft 20. The rotation direction and the output torque of the motor 81 are controlled by the EPS control unit 90. The gearbox 82 includes a reduction gear train that decelerates the rotation (increases the torque) output from the motor 81 and transmits the decreased rotation (increased torque) to the pinion shaft 22.

The EPS control unit 90 is a control device (motor controller) that supplies the indicated value of a current, which controls the rotation direction and the output torque, to the motor 81.

The EPS control unit 90 may be constituted by a microcomputer including an information processor, such as a central processing unit (CPU), storage units, such as a random access memory (RAM) and a read only memory (ROM), an input/output interface, and a bus that couples these elements to each other.

The EPS control unit 90 is able to obtain output from the steering angle sensor 71 and the torque sensor 72 and various items of information directly or via an in-vehicle local area network (LAN), such as a controller area network (CAN) communication system. Examples of the information that can be obtained by the EPS control unit 90 are information on the driving velocity of the vehicle (vehicle velocity) and information on the running states of other in-vehicle electronic devices.

When the vehicle is in the manual driving mode, the EPS control unit 90 sets the indicated value of the current to be supplied to the motor 81, based on the direction of the input torque and the torque value detected by the torque sensor 72.

The EPS control unit 90 includes a power supply device that supplies power having a voltage value and a current value based on the indicated value of the current to the motor 81 via a signal line.

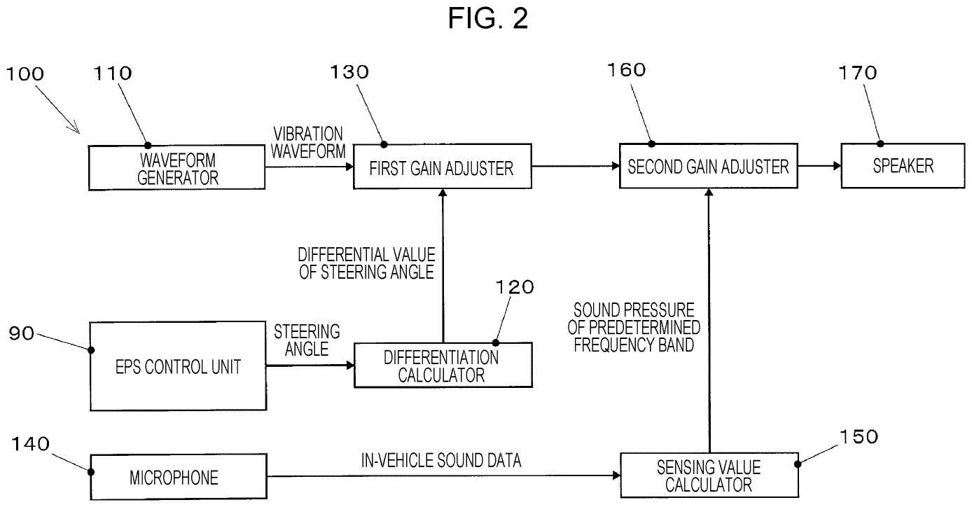

FIG. 2 is a block diagram schematically illustrating the system configuration of the main information transmission device 100 according to the first embodiment.

The main information transmission device 100 vibrates air around the ears of an occupant by using a speaker 170 disposed in the compartment of the vehicle to inform the occupant of a sign that the vehicle may exhibit certain behavior by using a sound signal.

The main information transmission device 100 includes a waveform generator 110, a differentiation calculator 120, a first gain adjuster 130, a microphone 140, a sensing value calculator 150, a second gain adjuster 160, and the speaker 170, for example.

The waveform generator 110 creates a vibration waveform, which is a waveform of a sound signal to be generated by the speaker 170.

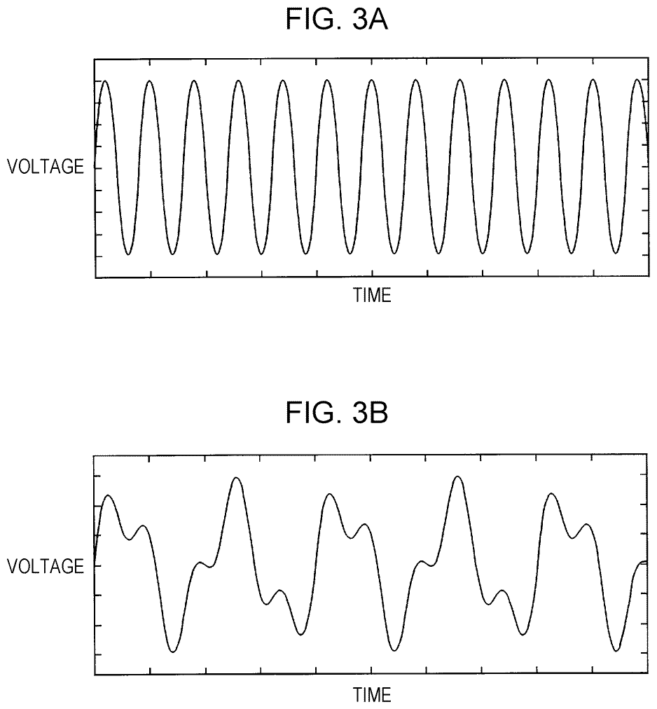

FIGS. 3A and 3B are graphs schematically illustrating examples of a vibration waveform generated in the main information transmission device 100. In FIGS. 3A and 3B, the horizontal axis indicates the time, and the vertical axis indicates the voltage (amplitude).

In one example, as illustrated in FIG. 3A, the vibration waveform may be a sine wave. In another example, as illustrated in FIG. 3B, the vibration waveform may be a waveform generated by superposing (combining) multiple sine waves having different wavelengths.

The vibration waveform is not limited to those in the above-described examples and may be changed suitably. For example, as the vibration waveform, various types of waveforms, such as a square wave, a triangle wave, and a waveform simulating the running sound of the vehicle, may be used singly or in combination with another waveform.

In the first embodiment, the frequency of the vibration waveform may be set so that its dominant frequency is included in a range of 100 to 400 Hz, for example, and more preferably, 150 to 300 Hz, for example. The reason for this will be explained below.

Examples of the sensory receptors of an occupant of the vehicle that can sense vibration when air around the occupant is vibrated are Merkel cells, Meissner corpuscles, and Pacinian corpuscles.

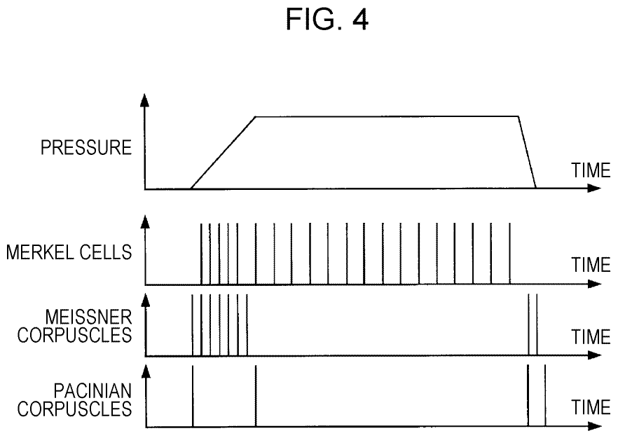

FIG. 4 is a graph schematically illustrating the timings of electric pulses generated by the sensory receptors when they are stimulated. In FIG. 4, the horizontal axis indicates the time, and the vertical axis sequentially indicates the pressure and the states of the electric pulses generated by the Merkel cells, Meissner corpuscles, and Pacinian corpuscles from the top to the bottom.

The Merkel cells respond to the pressure relatively slow and are responsive to DC components. The Meissner corpuscles are responsive to the rate of change (speed) of the contact pressure. The Pacinian corpuscles are responsive to a moment of transitional change and appear to have higher sensitivity than the Merkel cells and Meissner corpuscles. It is thus likely that the Pacinian corpuscles are a suitable sensory receptor having better sensitivity as the occupant's sensory receptor that can sense minute vibrations as the complex information of auditory and tactile senses.

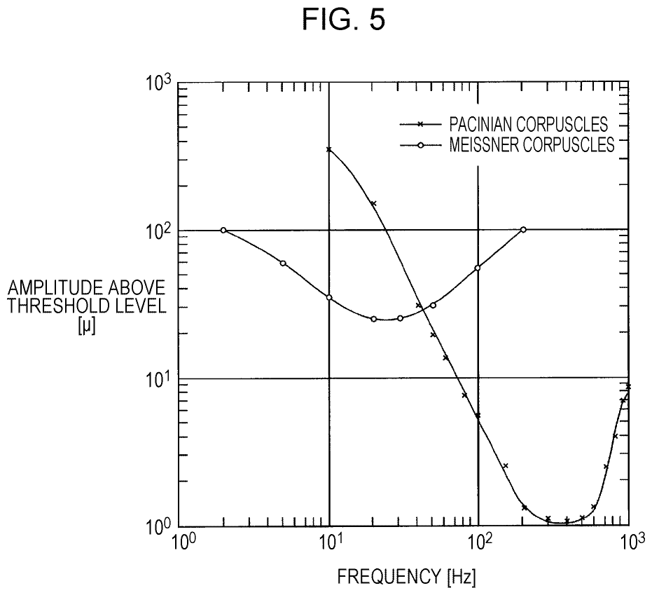

FIG. 5 is a graph illustrating the sensitivity distribution of the Pacinian corpuscles and that of the Meissner corpuscles with respect to the frequency. In FIG. 5, the horizontal axis indicates the frequency, and the vertical axis indicates the amplitude above the threshold level. As the value of the amplitude above the threshold level is smaller, the sensitivity is higher.

As illustrated in FIG. 5, the Pacinian corpuscles exhibit high sensitivity in a range of about 100 to 400 Hz and even higher sensitivity in a range of about 150 to 300 Hz. These ranges are included in a range of 20 Hz to 20 kHz, which is known as the humans'audible frequency range.

In one example, the dominant frequency of the vibration waveform may be set to be 250 Hz.

The differentiation calculator 120 obtains information on the steering angle θ of the wheel W detected by the steering angle sensor 71 from the EPS control unit 90 and calculates the differential value Δθ with respect to the time. The differentiation calculator 120 supplies the calculated differential values Δθ to the first gain adjuster 130 one after another.

The first gain adjuster 130 performs the following first gain adjustment for the fundamental wave of the vibration waveform generated by the waveform generator 110.

The first gain adjustment is to change the gain G1, which is the output gain to be multiplied by the voltage of the vibration waveform in accordance with the differential value (rate of change per unit time) of the steering angle θ of the steering device (parameter correlated to the steering amount).

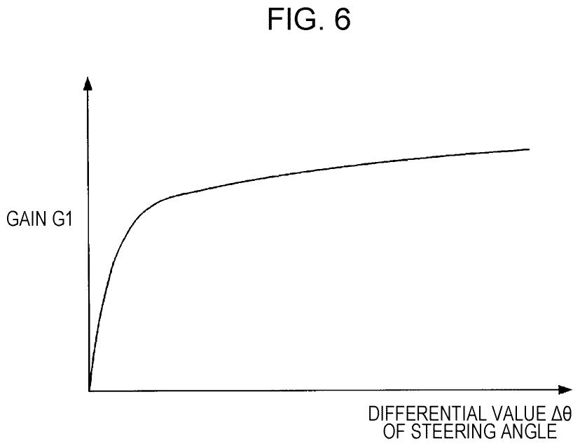

FIG. 6 is a graph schematically illustrating an example of the first gain adjustment performed by the first gain adjuster 130. In FIG. 6, the horizontal axis indicates the absolute value of the differential value Δθ of the steering angle θ of the front wheels F, and the vertical axis indicates the gain G1 to be multiplied by the voltage of the vibration waveform.

In one example, the gain G1 increases as the absolute value of the differential value Δθ becomes greater. The rate of increase of the gain G1 with respect to a rise in the absolute value of the differential value Δθ in the first gain adjuster 130 grows in a region where the absolute value of the differential value Δθ is small, and then decreases as the absolute value of the differential value Δθ becomes greater.

The gain G1 in the first gain adjuster 130 may be calculated from the absolute value of the differential value Δθ of the steering angle θ by using a logarithmic function.

The gain G1 may be expressed by the following equation (1).

$$Gain G 1 = log ( absolute value of the differential value Δθ of the steering angle \times coefficient k ) \qquad ( 1 )$$

The coefficient k may be a value which is set at the stage of developing the vehicle, for example, in accordance with the characteristics (the yaw rate gain with respect to the steering angle θ and the position of the center of gravity, for example) of the vehicle.

The microphone 140 is a sound collection device that is disposed in the compartment of the vehicle to collect background noise in the compartment.

The microphone 140 may be disposed at a position near the occupant's ears, such as at a headrest of a seat. The output from the microphone 140 is transmitted to the sensing value calculator 150.

The sensing value calculator 150 extracts components of a predetermined frequency band from the background noise obtained by the microphone 140 and outputs the sound pressure of the extracted components to the second gain adjuster 160 as a sensing value.

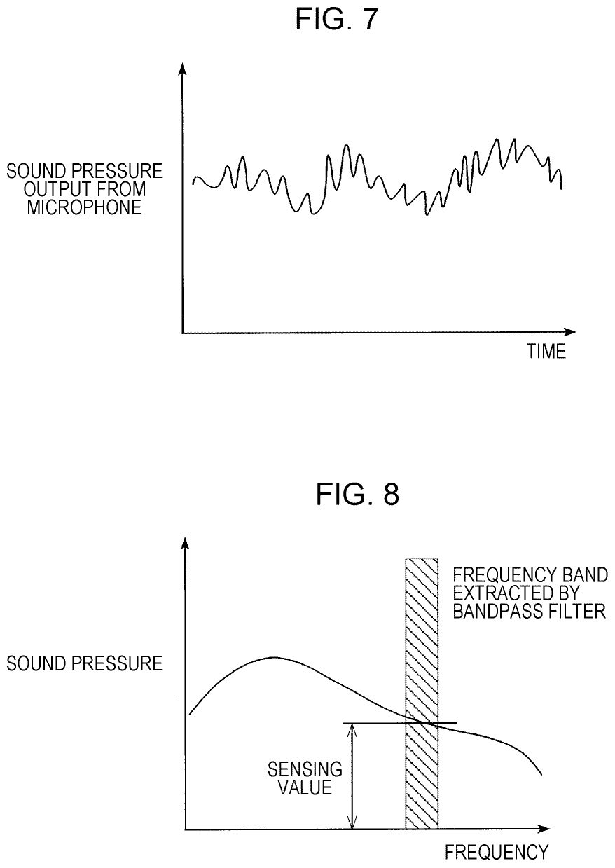

FIG. 7 is a graph schematically illustrating an example of the output history of the microphone 140. In FIG. 7, the horizontal axis indicates the time, and the vertical axis indicates the sound pressure of the background noise obtained by the microphone 140.

The sensing value calculator 150 performs fast Fourier transform (FFT) on a sound signal of the background noise obtained by the microphone 140 so as to transform the sound signal from the time domain into the frequency domain. The sensing value calculator 150 then performs bandpass filter processing on the resulting sound signal so as to extract frequency components of the predetermined frequency band. The frequency band of the frequency components to be extracted is set to include the dominant frequency of the vibration waveform output from the waveform generator 110.

The sensing value calculator 150 sets the average sound pressure of the extracted components of the frequency band to be the sensing value to be used for the second gain adjustment.

FIG. 8 is a graph illustrating an example of the correlation between the frequency and the sound pressure of the background noise. In FIG. 8, the horizontal axis indicates the frequency, and the vertical axis indicates the sound pressure.

In one example, the bandpass filter used in the bandpass processing of the sensing value calculator 150 may extract components in the frequency band around the dominant frequency (250 Hz, for example) of the vibration waveform output from the waveform generator 110. The sound pressure (average sound pressure, for example) of the extracted components in the frequency band is output to the second gain adjuster 160 as the sensing value.

The second gain adjuster 160 performs the following second gain adjustment on the vibration waveform subjected to the first gain adjustment.

The second gain adjustment is to change the gain of the vibration waveform in accordance with the sensing value of the noise in the compartment of the vehicle so as to adjust the output amplitude of the vibration waveform in accordance with a change in the background noise (such as noise produced from the drive system, aerodynamic noise, and road noise) while the vehicle is running.

The second gain adjuster 160 performs the second gain adjustment, based on the output from the sensing value calculator 150.

The second gain adjuster 160 sets the gain G2, based on the sensing value output from the sensing value calculator 150.

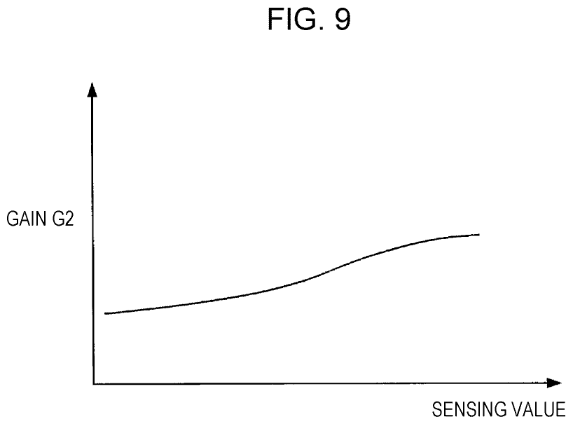

FIG. 9 is a graph schematically illustrating the gain adjustment performed by the second gain adjuster 160. In FIG. 9, the horizontal axis indicates the sensing value, and the vertical axis indicates the gain G2 to be multiplied by the voltage of the vibration waveform.

In one example, the gain G2 increases as the sensing value becomes greater.

The gain G2 is set so that the sound pressure of a sound signal having the vibration amplitude output from the speaker 170 does not become dominant over the sound pressure of the background noise around the occupant's ears. In one example, the gain G2 may be set so that the sound signal having the vibration amplitude is masked by the background noise of the vehicle to have a pressure level of sound that can be heard by the occupant unconsciously.

The output value (voltage) A of the vibration waveform subjected to the above-described first gain adjustment and second gain adjustment may be expressed by the following equation (2).

$$Output value A = output value of the waveform generator \times gain G 1 \times gain G 2 = output value of the waveform generator \times log ( absolute value of the differential value Δθ of the steering angle \times coefficient k ) \times gain G 2 \qquad ( 2 )$$

The speaker 170 is a main vibration device that is installed in the compartment of the vehicle and vibrates air around an occupant in the compartment by using the output value A to generate a sound signal. The installation location of the speaker 170 will be discussed later in detail.

As the speaker 170, a sound playback speaker of in-vehicle audio equipment may be used. Alternatively, as the speaker 170, a speaker specially used for the main information transmission device 100 may be provided.

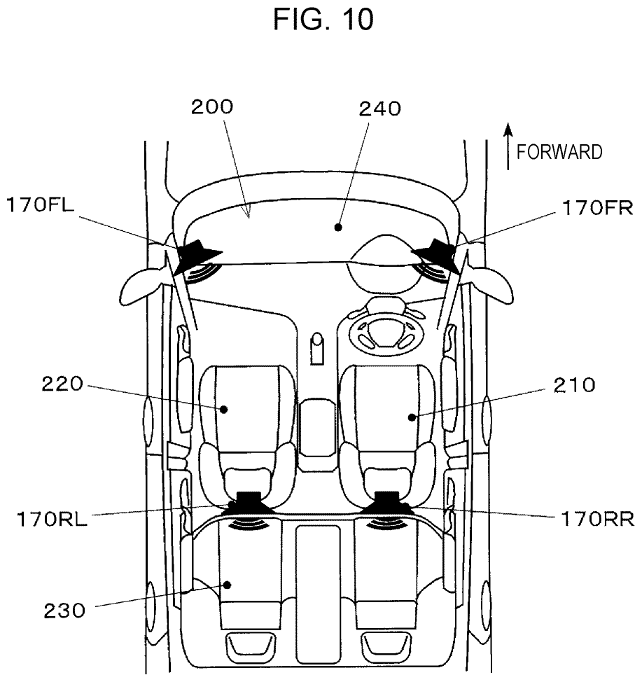

FIG. 10 schematically illustrates the arrangement in a compartment 200 of a vehicle equipped with the information transmission apparatus of the first embodiment.

Inside the compartment 200, a driver's seat 210, a passenger seat 220, a back seat 230, and an instrument panel 240, for example, are installed.

The driver's seat 210 and the passenger seat 220 are front seats installed in the front part of the compartment 200. The driver's seat 210 and the passenger seat 220 are located side by side in the widthwise direction of the vehicle.

In the example in FIG. 10, the vehicle is a right-hand drive vehicle in one example, and, with respect to the center in the left-right direction of the vehicle body, the driver's seat 210 is located on the right side, while the passenger seat 220 is located on the left side.

The driver's seat 210 and the passenger seat 220 are each equipped with a seat cushion on which the occupant's buttocks and thighs are placed, a seat back that supports the occupant's back, and a headrest that supports the occupant's head.

The back seat 230 is a bench-like seat installed at the back of the driver's seat 210 and the passenger seat 220. Two occupants, for example, can sit on the back seat 230 side by side.

The back seat 230 is equipped with a seat cushion on which the occupant's buttocks and thighs are placed, a seat back that supports the occupant's back, and a headrest that supports the occupant's head.

The right-hand part of the back seat 230 is located at the back of the driver's seat 210, while the left-hand part of the back seat 230 is located at the back of the passenger seat 220.

The instrument panel 240 is a member that is installed near the front end of the compartment 200 and houses various devices, such as a dashboard, an air conditioner, and an infotainment system, therein.

The instrument panel 240 is disposed to face the occupants sitting in the driver's seat 210 and the passenger seat 220.

In the example in FIG. 10, speakers 170 are installed separately in the front left, front right, rear left, and rear right parts of the compartment 200. For example, four speakers, that is, a front left speaker 170FL, a front right speaker 170FR, a rear left speaker 170RL, and a rear right speaker 170RR, are installed in the compartment 200.

The front right speaker 170FR is installed near the right end of the instrument panel 240. The front right speaker 170FR is a directional speaker having directivity toward the head (ears) of the occupant sitting in the driver's seat 210.

The front left speaker 170FL is installed near the left end of the instrument panel 240. The front left speaker 170FL is a directional speaker having directivity toward the head (ears) of the occupant sitting in the passenger seat 220.

The rear right speaker 170RR is installed on the headrest of the driver's seat 210. The rear right speaker 170RR is a directional speaker having directivity toward the head (ears) of the occupant sitting on the right side of the back seat 230.

The rear left speaker 170RL is installed on the headrest of the passenger seat 220. The rear left speaker 170RL is a directional speaker having directivity toward the head (ears) of the occupant sitting on the left side of the back seat 230.

In the first embodiment, with the above-described configuration, when a human driver steers and the steering angle θ of the wheels W is changed, a sound signal having an amplitude reflecting the differential value Δθ of the steering angle θ is emitted from the speaker 170 to the corresponding occupant.

This sound signal is masked by the running noise (background noise) of the vehicle. The occupant is thus unlikely to consciously recognize the sound signal as sound, but is able to unconsciously predict the occurrence of certain behavior of the vehicle accompanied by the lateral acceleration or yaw rate, for example.

The information transmission apparatus of the first embodiment includes the backup information transmission device 300 for a backup use. When the main information transmission device 100 malfunctions, the backup information transmission device 300 vibrates air around the occupant to generate a pseudo-sound signal on behalf of the main information transmission device 100.

The backup information transmission device 300 is used when a malfunction occurs in a certain element of the main information transmission device 100, such as the speaker 170 or the first and second gain adjusters 130 and 160.

The information transmission apparatus of the first embodiment includes a malfunction detector, which is not illustrated, that detects a malfunction of a sound generating device, such as the speaker 170.

The backup information transmission device 300 is activated when the malfunction detector has detected a malfunction of the main information transmission device 100.

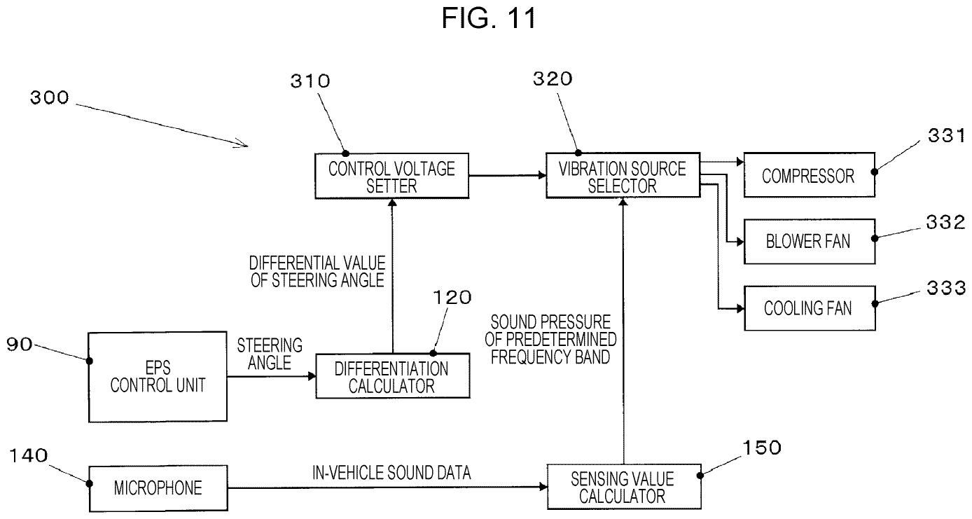

FIG. 11 schematically illustrates the system configuration of the backup information transmission device 300 of the information transmission apparatus of the first embodiment.

The backup information transmission device 300 vibrates air around the occupant's ears by using the vibration generated by a compressor 331 of the air conditioner, which is auxiliary equipment whose purpose of use is not to generate sound, so as to inform the occupant of a sign that the vehicle may exhibit certain behavior by using sound information.

The backup information transmission device 300 includes a control voltage setter 310, a vibration source selector 320, and auxiliary equipment, such as the compressor 331.

The control voltage setter 310 sets the basic value of the drive voltage for driving the sound generating auxiliary equipment, such as the compressor 331, based on the differential value Δθ of the steering angle θ of the wheel W output from the differentiation calculator 120. In one embodiment, the control voltage setter 310 may form a “vibration adjuster”, together with the vibration source selector 320.

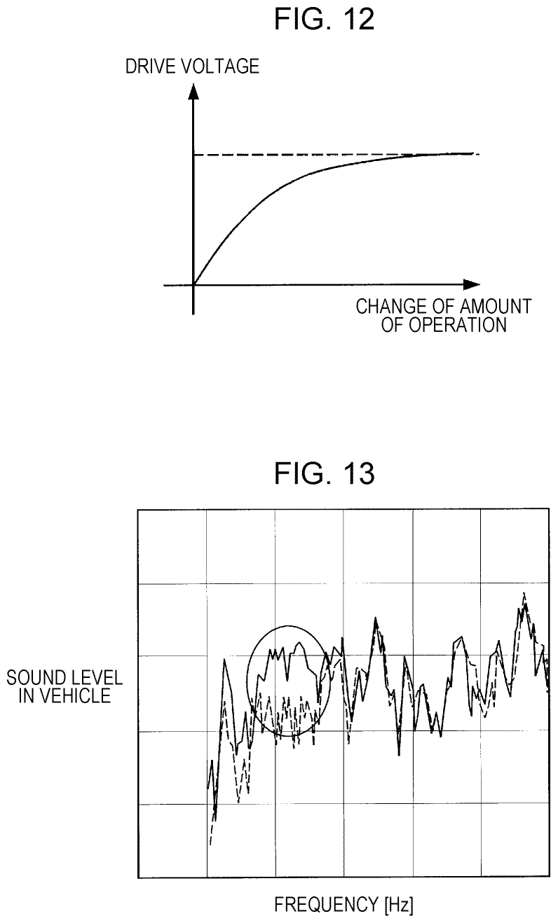

FIG. 12 is a graph illustrating the setting of the drive voltage by the control voltage setter 310. In FIG. 12, the horizontal axis indicates a change of the amount of operation (differential value Δθ of the steering angle θ, for example) of a driving operation device, and the vertical axis indicates the drive voltage.

As illustrated in FIG. 12, in a region where a change of the amount of operation is a predetermined value or smaller, the drive voltage may increase as a change of the amount of operation becomes greater. In a region where a change of the amount of operation is greater than the predetermined value, the drive voltage may become constant.

The above-described control for the drive voltage can be performed by known pulse width modulation (PWM) control.

The vibration source selector 320 selects the type of device (vibration source) and the number of devices to be driven by the drive voltage set by the control voltage setter 310.

The vibration source selector 320 selects more devices (vibration sources) to be driven as the sensing value output from the sensing value calculator 150 becomes greater.

For example, if the sensing value is relatively small and a sufficient level of sound pressure near the occupant's ears can be obtained only with the driving of the compressor 331, the vibration source selector 320 selects the compressor 331 as a device to be driven.

FIG. 13 is a graph illustrating the difference in the sound level in the compartment of the vehicle in accordance with whether the compressor 331 is ON or OFF. In FIG. 13, the horizontal axis indicates the frequency, and the vertical axis indicates the sound level in the compartment of the vehicle.

In FIG. 13, data when the compressor 331 is OFF is represented by the broken line, while data when the compressor 331 is ON is represented by the solid line.

As illustrated in FIG. 13, by turning ON the compressor 331, the sound pressure can be increased in a range of 150 to 300 Hz, for example, where the Pacinian corpuscles can be stimulated.

Information presentation according to an embodiment of the disclosure becomes useful when the vehicle is driving on a slippery road, such as an icy or snowy road. When the vehicle is driving on an icy or snowy road, the need for a cooling function of the air conditioner is relatively small. By turning ON the compressor 331 in such a situation, the effect of generating a sound signal can be increased.

In the case of a device which generates vibration by utilizing the rotation of an electric motor, such as the compressor 331, a blower fan 332, and a cooling fan 333, the revolutions per minute (rpm) of the electric motor and the frequency of vibration to be generated are changed in accordance with the value of the voltage.

The control voltage setter 310 can thus vary the frequency of vibration to be generated by changing the magnitude of the voltage. For example, the control voltage setter 310 can vary the frequency so that the frequency matches or does not match the frequency range in which the Pacinian corpuscles exhibit high sensitivity, thereby making it possible to change the level of the information transmission effect.

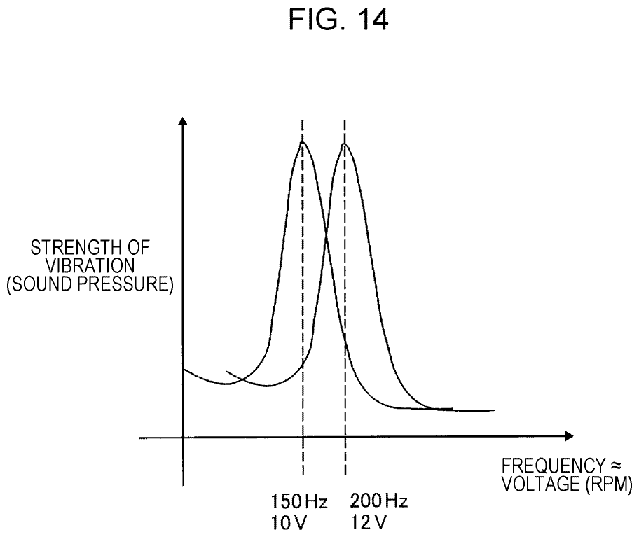

FIG. 14 is a graph schematically illustrating an example of the vibration generation characteristics of a motor or a compressor. In FIG. 14, the horizontal axis indicates the frequency (approximating to the voltage and the rpm), and the vertical axis indicates the strength of the vibration (sound pressure).

In one example, when the voltage is lowered, the frequency is decreased, and the decreased frequency is in the range in which the Pacinian corpuscles exhibit low sensitivity. When the voltage is raised based on the operation of the driving operation device, the frequency is increased, and the increased frequency matches the range in which the Pacinian corpuscles exhibit high sensitivity, thereby enhancing the information transmission effect.

The magnitude of the voltage can be controlled by analog adjustment or digital adjustment using a pulse signal, such as PWM.

Changing the voltage in this manner can shift the dominant frequency in FIG. 14 to a higher range or a lower range. If the shifted dominant frequency matches the region where humans'sensitivity is high, the occupant receives information transmission more effectively. If the shifted dominant frequency does not match the region where humans'sensitivity is high, the occupant receives information transmission less effectively.

If it is not possible to obtain a sufficient level of sound pressure near the occupant's ears only with the driving of the compressor 331, the vibration source selector 320 sequentially selects other devices, such as the blower fan 332 used for air conditioning and the cooling fan 333 used for cooling a radiator core.

According to the first embodiment, the following advantages can be obtained.
(1) Even when a malfunction occurs in an element, such as the speaker 170, of the main information transmission device 100, auxiliary equipment having a function other than a sound generating function, such as the compressor 331 for an air conditioner, is used as a vibration source of the backup information transmission device 300 to vibrate air around the occupant's ears. This can improve the occupant's predictability regarding how the vehicle will behave in response to a driving operation of the vehicle.

By using a device, which is usually provided in a regular vehicle, as a vibration generator, even upon the occurrence of a malfunction in the main information transmission device 100, the loss of the function of the information transmission apparatus can be avoided without providing an extra device for the sound generating function.
(2) By setting the compressor 331 or the blower fan 332 used for the air conditioner, which is usually provided in a regular vehicle, as a vibration generator, even upon the occurrence of a malfunction in an element of the main information transmission device 100, such as the speaker 170, air around the occupant's ears can be vibrated with such a vibration generator.
(3) The information transmission apparatus includes the main information transmission device 100 that emits a predetermined vibration waveform from the speaker 170 in accordance with the amount of change of a parameter per unit time and a malfunction detector that detects a malfunction of the main information transmission device 100. The information transmission apparatus activates the backup information transmission device 300 only when a malfunction of the main information transmission device 100 is detected. In an embodiment, the backup information transmission device 300 may serve as a “sound transmission device”.
(4) The vibration generator generates vibration having a dominant frequency included in the frequency range of 100 to 400 Hz. This can use a suitable sensory receptor, such as the Pacinian corpuscles, that exhibit high sensitivity in the audible range and as the skin sensation, and allows an occupant to recognize the sound and perceive the skin sensation effectively, thereby making it possible to transmit information to the occupant.
(5) The parameter includes one or more of the steering angle of a steering device, steering torque of the steering device, driving torque of a drive device, and braking torque of a braking device. The parameter can thus be suitably used to identify the driving operation regarding the turning and the acceleration/deceleration of the vehicle and can be reflected in vibration control.

### Second Embodiment

An information transmission apparatus according to a second embodiment of the disclosure will now be described below.

In the second embodiment, a vehicle has an autonomous driving function that autonomously performs operations, such as steering and acceleration/deceleration, without depending on the driving operation of a human driver.

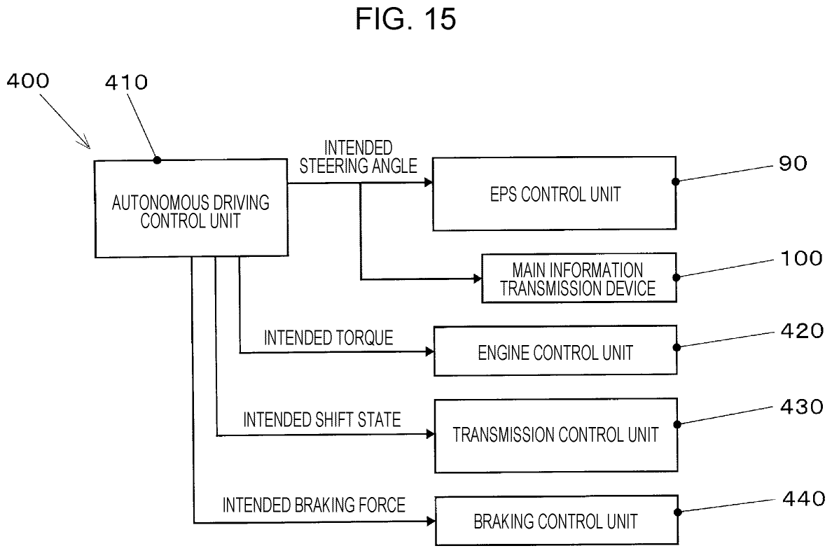

FIG. 15 is a block diagram schematically illustrating the configuration of an autonomous driving system 400 of a vehicle equipped with the information transmission apparatus of the second embodiment.

The autonomous driving system 400 includes an autonomous driving control unit 410, an engine control unit 420, a transmission control unit 430, and a braking control unit 440, for example, in addition to the above-described EPS control unit 90.

These units are each constituted by a microcomputer including an information processor, such as a CPU, storage units, such as a RAM and a ROM, an input/output interface, and a bus that couples these elements to each other.

These units are coupled to each other directly or via an in-vehicle LAN, such as the CAN communication system, and are able to communicate with each other.

The autonomous driving control unit 410 recognizes the environment around the vehicle by using various sensors, such as a stereo camera, a millimeter wave radar, and a laser scanner, and a high-precision 3D map.

The autonomous driving control unit 410 then generates an autonomous driving scenario including information on a driving line and the velocity of the vehicle, based on the recognized environment.

Based on the generated autonomous driving scenario, the autonomous driving control unit 410 provides instructions to the EPS control unit 90, the engine control unit 420, the transmission control unit 430, and the braking control unit 440 so as to control the steering and the acceleration/deceleration of the vehicle.

Instead of receiving a steering operation from a human driver as in the first embodiment, the EPS control unit 90 controls the actuator unit 80 to steer the wheels W in accordance with the intended steering angle indicated by the instruction from the autonomous driving control unit 410.

The engine control unit 420 centrally controls the engine, which is the driving power source of the vehicle, and auxiliary equipment for the engine.

The engine control unit 420 controls output from the engine so that the torque generated by the engine matches the intended torque indicated by the instruction from the autonomous driving control unit 410.

The transmission control unit 430 centrally controls the transmission that changes (increases or decreases) the rotation of the output shaft of the engine and the auxiliary equipment for the transmission.

The transmission control unit 430 switches the position of the select lever of the transmission between the drive range and the non-drive range, switches between forward movement and backward movement of the vehicle, and changes the gear ratio when the vehicle drives forward, in accordance with the instruction from the autonomous driving control unit 410.

The braking control unit 440 controls braking force of a hydraulic service brake provided in each wheel of the vehicle.

The braking control unit 440 controls the hydraulic pressure of a brake fluid to be supplied to a wheel cylinder of each wheel in accordance with the intended braking force indicated by the instruction from the autonomous driving control unit 410 and causes each wheel to generate the intended braking force.

In the second embodiment, basically, even when autonomous driving is being performed without the intervention of a human driver, the intended steering angle provided from the autonomous driving control unit 410 to the EPS control unit 90 is used as input into the main information transmission device 100 (as a parameter correlated to the steering angle of the steering device), and based on the differential value of the intended steering angle, the first gain adjustment is performed.

When the main information transmission device 100 malfunctions, the backup information transmission device 300 is activated with the intended steering angle.

In the above-described second embodiment, in the autonomous driving vehicle, too, when the vehicle starts steering under autonomous driving control, sound is generated in accordance with the absolute value of the differential value of the steering angle. This enables an occupant of the vehicle to foresee the occurrence of certain behavior of the vehicle accompanied by the lateral acceleration, yaw rate, or roll angle, for example, and avoids the occupant from feeling that the behavior of the vehicle is abruptly exhibited.

In the second embodiment, as well as the first embodiment, when the speaker 170, for example, malfunctions, various devices, such as the compressor 331, can be used as vibration sources to vibrate air around the occupant's ears.

### Modified Examples

The disclosure is not limited to the above-described first and second embodiments, and various modifications and alterations may be made. Embodiments obtained by modifying and changing the above-described embodiments are also encompassed in the technical scope of the disclosure.
(1) The configurations of the information transmission apparatus and the vehicle are not limited to those discussed in the embodiments and may be changed appropriately.

For example, the hardware configuration of the information transmission apparatus and the specific methods for the gain adjustments for the vibration waveform are not limited to those discussed in the embodiments and may be changed appropriately.
(2) In the above-described embodiments, as the parameter correlated to the steering amount of the steering device, the steering angle (actual steering angle detected by the steering angle sensor 71 or the intended steering angle in autonomous driving control), for example, is used. The parameter is not limited to the steering angle and may be changed appropriately.

For example, the parameter may be one or more of the steering torque (input torque) input from a human driver, the activation amount of the actuator (the rpm of the motor, for example) that steers the wheels, and the indicated value output to the actuator.
(3) The disclosure may be applicable to, not only a vehicle in which an operation member, such as the steering wheel, and a steering mechanism, such as a steering gearbox, are mechanically coupled with each other as in the embodiments, but also a vehicle including a steer-by-wire steering device in which the operation member, such as the steering wheel, and the steering mechanism are not mechanically coupled with each other. In the case of the second type of vehicle, as the parameter correlated to the steering amount of the steering device, the actual steering angle of the front wheels and the state of the steering mechanism (the rotation angle/position of the pinion gear and the movement amount of the rack shaft, for example) may be used.
(4) In the above-described embodiments, the level of the background noise is obtained by the microphone as an example. However, the level of the background noise may be obtained by another approach. For instance, the level of the background noise may be estimated based on the acceleration of the unsprung weight part of the vehicle, which is correlated to the input from the road surface, or the output value (torsion bar torque) from the torque sensor 72 of the steering device.
(5) In the first embodiment, regarding the driving operation performed by a human driver on the driving operation device, the steering amount or the steering torque is used as a parameter indicating the amount of operation performed on the steering device. However, another value may be used as the parameter.

In one example, the amount of operation performed on an accelerator pedal or the intended torque based on this amount of operation may be used as a parameter indicating the amount of operation, and based on a change in the amount of operation, sound may be generated.

In another example, the amount of operation performed on a brake pedal or the target braking force based on this amount of operation may be used as a parameter indicating the amount of operation, and based on a change in the amount of operation, sound may be generated.

As described above, according to an embodiment of the disclosure, it is possible to provide an information transmission apparatus that can improve the predictability of an occupant of a vehicle regarding how the vehicle will behave in response to a driving operation of the vehicle even when a malfunction occurs in an element of the information transmission apparatus, such as a speaker.

The main information transmission device 100 illustrated in FIG. 2 and the backup information transmission device 300 illustrated in FIG. 11 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the main information transmission device 100 including the EPS control unit 90, the waveform generator 110, the differentiation calculator 120, the first gain adjuster 130, the microphone 140, the sensing value calculator 150, the second gain adjuster 160, and the speaker 170 and the backup information transmission device 300 including the EPS control unit 90, the differentiation calculator 120, the microphone 140, the sensing value calculator 150, the control voltage setter 310, and the vibration source selector 320. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 2 and 11.

1. An information transmission apparatus configured to be provided in a vehicle, the information transmission apparatus comprising:
a parameter detector configured to detect a parameter correlated to an amount of operation of a driving operation device of the vehicle;
a main information transmission device configured to generate a predetermined vibration waveform in accordance with an amount of change of the parameter per unit time;
a vibration generator configured to generate vibration to be applied to air around an occupant of the vehicle, the vibration generator having a function other than a function of generating vibration;
a vibration adjuster configured to adjust magnitude of the vibration to be generated by the vibration generator in accordance with the amount of change of the parameter per unit time; and
a malfunction detector configured to detect a malfunction of the main information transmission device,
wherein the vibration adjuster is configured to drive the vibration generator when a malfunction of the main information transmission device is detected.

2. The information transmission apparatus according to claim 1, wherein the vibration generator is one or more of a compressor of an air conditioner, a blower fan of the air conditioner, and a cooling fan of a radiator core.

3. The information transmission apparatus according to claim 1, wherein:
the vibration generator includes multiple devices that are individually drivable; and
the vibration adjuster is configured to select a device to be driven from the multiple devices in accordance with sound pressure of the vibration to be generated by the vibration generator.

4. The information transmission apparatus according to claim 3, further comprising:
a sound collection device configured to collect background noise in a compartment of the vehicle; and
a calculator configured to calculate sound pressure of the background noise,
wherein the vibration adjuster is configured to select a device to be driven from the multiple devices in accordance with the sound pressure of the background noise.

5. The information transmission apparatus according to claim 1, wherein the vibration generator is configured to generate vibration having a dominant frequency included in a frequency band of 100 to 400 Hz.

6. The information transmission apparatus according to claim 1, wherein the parameter includes a parameter correlated to one or more of a steering angle of a steering device, a steering torque of the steering device, a driving torque of a drive device, and a braking torque of a braking device.

7. An information transmission apparatus configured to be provided in a vehicle, the information transmission apparatus comprising:
circuitry configured to
detect a parameter correlated to an amount of operation of a driving operation device of the vehicle,
generate a predetermined vibration waveform in accordance with an amount of change of the parameter per unit time,
cause a vibration generator to generate vibration to be applied to air around an occupant of the vehicle, the vibration generator having a function other than a function of generating vibration,
adjust magnitude of the vibration to be generated by the vibration generator in accordance with the amount of change of the parameter per unit time,
detect a malfunction of the information transmission apparatus, and
drive the vibration generator when a malfunction of the information transmission apparatus is detected.
